(19) United States
(12) Patent Application Publication
(10) Pub. No.: US 2025/0390306 A1
(43) Pub. Date: Dec. 25, 2025

(54) APPARATUS AND METHOD FOR HIDING CACHE TAG ACCESS LATENCY

(71) Applicant: Electronics and Telecommunications Research Institute, Daejeon (KR)

(72) Inventors: Kyung-Min KIM, Daejeon (KR); Woo-Jong Han, Daejeon (KR); Shin-Young Ahn, Daejeon (KR); Seon-Young Kim, Daejeon (KR)

(73) Assignee: Electronics and Telecommunications Research Institute, Daejeon (KR)

(21) Appl. No.: 19/242,034

(22) Filed: Jun. 18, 2025

(30) Foreign Application Priority Data
Jun. 24, 2024 (KR) 10-2024-0081949
May 22, 2025 (KR) 10-2025-0066665

(51) Int. Cl. G06F 9/30; G06F 9/38; G06F 12/0871; G06F 12/0884

(52) U.S. Cl. CPC G06F 9/30047; G06F 9/30145; G06F 9/38585; G06F 12/0871; G06F 12/0884

(57) ABSTRACT

Disclosed herein is an apparatus and method for hiding cache tag access latency. The apparatus includes main memory, cache memory including multiple cache entries, and a core for processing instructions. The core may include an internal register for storing data of the multiple cache entries of the cache memory and a tag comparison unit for comparing the tag of a memory address with each of the tags of the multiple cache entries stored in the internal register and may perform a data read or write operation corresponding to the memory address based on the result of comparing the tag.

### CROSS REFERENCE TO RELATED APPLICATIONS

This application claims the benefit of Korean Patent Application No. 10-2024-0081949, filed Jun. 24, 2024, and No. 10-2025-0066665, filed May 22, 2025, which are hereby incorporated by reference in their entireties into this application.

### BACKGROUND OF THE INVENTION

### 1. Technical Field

The disclosed embodiment relates to technology for a core to control cache memory access.

### 2. Description of the Related Art

Cache memory is a device that stores copies of data frequently or recently used by cores to mitigate the performance difference between relatively fast cores and slow main memory in a computer hardware architecture. Data between the core and the cache memory is transmitted in units of words, which are the basic processing unit of the core, and data between the cache memory and the main memory is transmitted in units of blocks, each of which is composed of multiple words.

Recently, global CPU, GPU, and NPU vendors have released products that increase the capacity of cache memory to improve core performance. An increase in the capacity of cache memory reduces the cache capacity miss rate by allocating more cache entries in a cache set, thereby improving Average Memory Access Time (AMAT).

However, a continuous increase in the capacity of cache memory increases the area, resulting in an increase in the distance between the core and the cache memory and an increase in the complexity of cache memory implementation, such as address decoding, data retrieval, and the like. As a result, hit latency may increase. When instruction/data cache access corresponds to the critical path latency of the core due to the increase in the hit latency, the performance of the core may be degraded.

In other words, increasing the capacity of cache memory may reduce AMAT by reducing the cache capacity miss rate, but the critical path of the core may become instruction fetch or memory access, which accesses the cache memory.

When cache memory access becomes the critical path as described above, the operating frequency of the core is determined by the cache memory access time, which is the critical path delay, and this affects the performance of the core. Therefore, it is necessary to improve the cache memory access time.

### SUMMARY OF THE INVENTION

An object of the disclosed embodiment is to improve the performance of a core by reducing the time taken for the core to access cache memory.

A method for hiding cache tag access latency according to an embodiment may include transferring, by a core, a memory address to cache memory, transferring, by the core, data of the cache memory to an internal register of the core, comparing, by the core, a tag included in the memory address with each of tags of cache entries stored in the internal register, and performing, by the core, a data read operation corresponding to the memory address based on a result of comparing the tag.

Here, comparing the tag and performing the data read operation may be performed in parallel while the core performs instruction decode or write back.

Here, transferring the data of the cache memory may comprise transferring a tag and a word corresponding to a block offset in each of cache entries having a valid bit of 1 to the internal register under an assumption of a cache hit.

Here, performing the data read operation may comprise transferring a valid signal to a cache-hit word when the result of comparing the tag is a cache hit.

Here, performing the data read operation may include, when the result of comparing the tag is a cache miss, transferring, by the core, an invalidation signal for all operations that assumed a cache hit, allocating a cache entry and copying a cache entry from main memory, and transferring a word corresponding to a block offset in the cache entry copied from the main memory to the internal register as read data.

A method for hiding cache tag access latency according to an embodiment may include transferring, by a core, a memory address to cache memory, transferring, by the core, data of the cache memory to an internal register of the core, comparing, by the core, a tag included in the memory address with each of tags of cache entries stored in the internal register, and performing, by the core, a data write operation corresponding to the memory address based on a result of comparing the tag.

Here, comparing the tag and performing the data write operation may be performed in parallel while the core performs instruction decode or write back.

Here, transferring the data of the cache memory may comprise transferring a tag and a word corresponding to a block offset in each of cache entries having a valid bit of 1 to the internal register under an assumption of a cache hit.

Here, performing the data write operation may comprise transferring write data stored in the internal register to a word corresponding to a block offset when the result of comparing the tag is a cache hit.

Here, performing the data write operation may comprise, when the result of comparing the tag is a cache miss, allocating a cache entry and copying a cache entry from main memory.

An apparatus for hiding cache tag access latency according to an embodiment includes main memory, cache memory including multiple cache entries, and a core for processing instructions. The core may include an internal register for storing data of the multiple cache entries of the cache memory and a tag comparison unit for comparing a tag of a memory address with each of tags of the multiple cache entries stored in the internal register and may perform a data read or write operation corresponding to the memory address based on a result of comparing the tag.

Here, while the core performs instruction decode or write back, the core may execute the tag comparison unit in parallel and perform the data read operation based on the result of comparing the tag.

Here, the core may transfer a tag and a word corresponding to a block offset in each of cache entries having a valid bit of 1 to the internal register under an assumption of a cache hit.

Here, when performing the data read operation, the core may transfer a valid signal to a cache-hit word if the result of comparing the tag is a cache hit.

Here, when performing the data read operation, if the result of comparing the tag is a cache miss, the core may transfer an invalidation signal for all operations that assumed a cache hit, allocate a cache entry and copy a cache entry from the main memory, and transfer a word corresponding to a block offset in the cache entry copied from the main memory to the internal register as read data.

Here, while the core performs instruction decode or write back, the core may execute the tag comparison unit in parallel and perform the data write operation based on the result of comparing the tag.

Here, when performing the data write operation, the core may transfer write data stored in the internal register to a word corresponding to a block offset if the result of comparing the tag is a cache hit.

Here, when performing the data write operation, the core may allocate a cache entry and copy a cache entry from the main memory if the result of comparing the tag is a cache miss.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a schematic block diagram of an apparatus for hiding cache tag access latency according to an embodiment;

FIG. 2 is an exemplary view of a structure diagram of cache memory;

FIG. 3 is an exemplary view of an instruction pipeline of a core;

FIG. 4 is the structure of an instruction pipeline of a core according to an embodiment;

FIG. 5 is a flowchart of an operation of reading from an instruction/data cache in a method for hiding cache tag access latency according to an embodiment;

FIG. 6 is an exemplary view for explaining a read operation when an instruction/data cache hit occurs in a conventional method;

FIG. 7 is an exemplary view for explaining a read operation when an instruction/data cache hit occurs according to an embodiment;

FIG. 8 is an exemplary view for explaining a read operation when an instruction/data cache miss occurs in a conventional method;

FIG. 9 is an exemplary view for explaining a read operation when an instruction/data cache miss occurs according to an embodiment;

FIG. 10 is a flowchart of an operation of writing to an instruction/data cache in a method for hiding cache tag access latency according to an embodiment;

FIG. 11 is an exemplary view for explaining a write operation when an instruction/data cache hit occurs in a conventional method;

FIG. 12 is an exemplary view for explaining a write operation when an instruction/data cache hit occurs according to an embodiment;

FIG. 13 is an exemplary view for explaining a write operation when an instruction/data cache miss occurs in a conventional method; and

FIG. 14 is an exemplary view for explaining a write operation when an instruction/data cache miss occurs according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

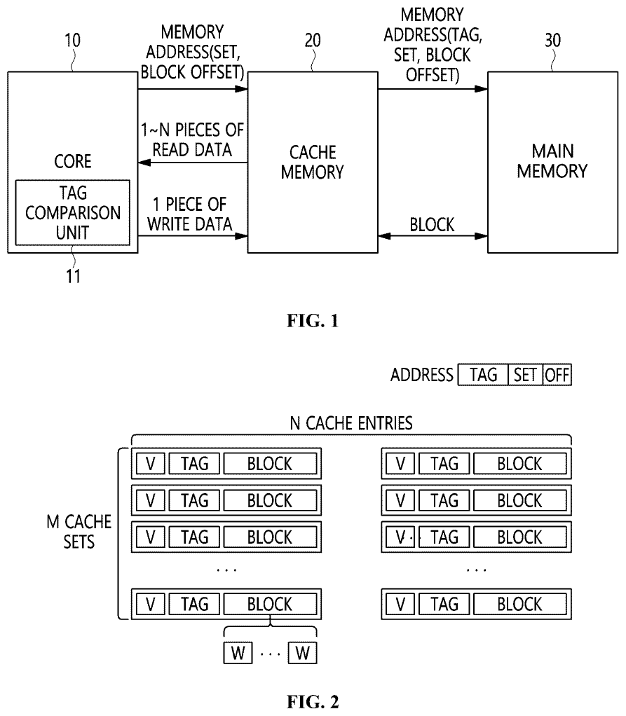

FIG. 1 is a schematic block diagram of an apparatus for hiding cache tag access latency according to an embodiment, and FIG. 2 is an exemplary view of a structure diagram of cache memory.

Referring to FIG. 1, the apparatus for hiding cache tag access latency according to an embodiment may include a core 10, cache memory 20, and main memory 30.

The cache memory 20 stores copies of data that is frequently used or recently used by the core 10.

Referring to FIG. 2, the cache memory 20 includes up to M cache sets, each of which includes up to N cache entries.

Here, each of the N cache entries may include a block composed of multiple words (W) for storing data, a valid bit (V) indicating whether valid data is stored in the block, and a tag that is a unique identification value of the cache entry.

A memory address may include a tag for comparison with the tag in the cache entry, which is a unique identification value in the cache entry, a set index indicating the location of a cache set, and a block offset indicating the location of a word in the block.

Here, when there is a cache entry having a valid bit of 1 and a tag identical to the tag of the memory address, among multiple cache entries in the set indicated by the set index of the memory address, this indicates that data that the core 10 intends to access is present in the cache memory 20, which is called a cache hit.

When a cache hit occurs during a read operation, the core 10 loads the word corresponding to the block offset in the cache-hit cache entry as read data.

Also, when a cache hit occurs during a write operation, the core 10 stores write data at the word corresponding to the block offset in the cache-hit cache entry.

Conversely, when all of the valid bits (V) of the multiple cache entries in the set indicated by the set index of the memory address are 0 or when a tag identical to the tag of the memory address does not exist in any of the multiple cache entries, this indicates that data that the core 10 intends to access is not present in the cache memory 20, which is called a cache miss.

When a cache miss occurs during a read operation, the cache memory 20 allocates a new cache entry at the location indicated by the set index and copies a cache entry from the main memory 30, and then the core 10 loads the word corresponding to the block offset in the copied cache entry as read data.

Also, when a cache miss occurs during a write operation, the cache memory 20 allocates a new cache entry at the location indicated by the set index and copies data from the main memory 30 into the cache entry, and the core 10 stores write data at the word corresponding to the block offset in the copied cache entry.

Referring to FIG. 1 again, in an embodiment, tag comparison is performed by the core 10, so a tag comparison unit 11 is included in the core 10, not in the cache memory 20.

The interface between the core 10 and the cache memory 20 receives a signal when the cache memory 20 is accessed, and it includes a memory address (a set index and a block offset), 1˜N pieces of read data, and one piece of write data.

In this case, the memory address (a set index and a block offset) is the address used by the core 10 to access the cache memory 20.

Also, the 1˜N pieces of read data are valid cache entries in the set indicated by the set index, which is data temporarily loaded without tag comparison when the core 10 performs a read or write operation on an instruction/data cache, and the read data includes a tag and a word.

Here, the number of pieces of read data may vary according to a cache placement policy, based on which the core10 determines the location in the cache memory 20 at which the data copied from the main memory 30 is to be placed.

Representative cache placement policies include direct-mapped, fully associative, and set associative cache policies.

Here, the direct-mapped cache includes M sets, each of which includes a single cache entry, so it can be represented as an M×1 matrix. Because a tag within a single cache entry included in the set indicated by the set index needs to be compared, only a single comparator is required. Therefore, hardware implementation is simple, and less power is consumed. However, only a single cache entry can be stored in each set, so the cache hit rate is low.

The fully associative cache includes a single set including N cache entries, so it can be represented as a 1×N matrix. Because memory blocks can be stored in any N cache entries, the cache memory 20 may be used to the maximum, and the cache hit rate is high. However, it is necessary to compare tags in the N cache entries, N comparators, an N-to-1 multiplexer, N input OR gates, and the like are required, which may complicate hardware implementation and consume more power.

The set associative cache includes M sets, each of which includes N cache entries, so it can be represented as an M× N matrix. The set associative cache adopts the direct-mapped cache and the fully associative cache in a balanced way to have the advantages of the two policies, so it is most commonly used.

Therefore, the read data may be a single piece of read data in the case of the direct-mapped cache but may be N pieces of read data in the case of the fully associative cache or the set associative cache in which each set includes N cache entries.

One piece of write data is the data to be stored when the core 10 performs a write operation on the cache memory 20.

Meanwhile, the interface between the cache memory 20 and the main memory 30 transmits and receives signals when a cache miss occurs, and may include a memory address (a tag, a set index, and a block offset) and a block signal.

Here, the memory address (a tag, a set index, and a block offset) is the address used by the core 10 to access the main memory 30 when a cache miss occurs.

The block is a specific unit of data that the core 10 reads or writes by accessing the main memory 30 corresponding to the memory address, and it includes multiple words.

Meanwhile, the core 10 uses an instruction pipeline technique to divide a single instruction into multiple stages and execute multiple instructions at the same time.

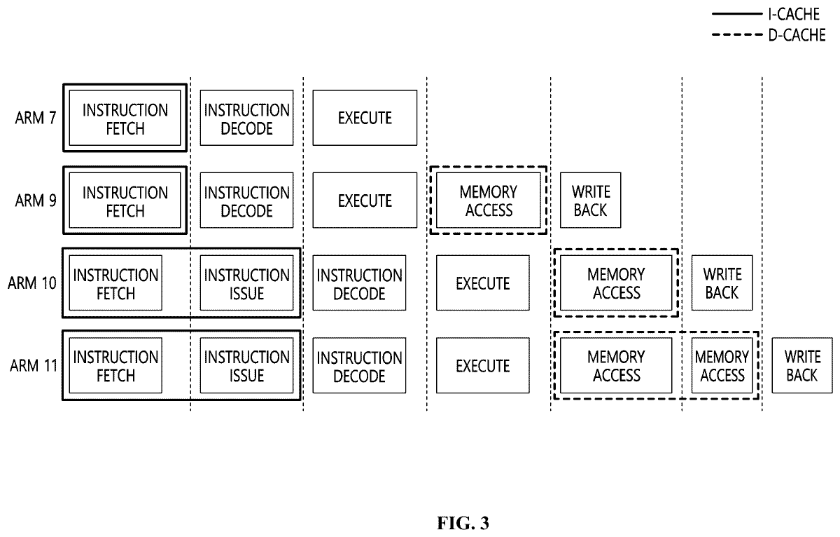

FIG. 3 is an exemplary view of an instruction pipeline of a core.

Referring to FIG. 3, because a module for operating each function is configured for each stage of an instruction pipeline in the core 10, the core 10 may perform different operations for the same amount of time.

By default, the instruction pipeline operates in the order of Instruction Fetch (IF), Instruction Decode (ID), Execution (EX), Memory Access (MEM), and Write Back (WB).

Here, the stage in which the core 10 accesses the instruction cache is instruction fetch (IF), and the stage in which the core 10 accesses the data cache is memory access (MEM). The remaining stages are performed inside the core 10.

However, as the ARM architecture illustrated in FIG. 3 has evolved, it separates the stages for accessing the I-Cache and D-Cache. That is, it implies that the critical path in the instruction pipeline of the core 10 is Instruction Fetch (IF) and Memory Access (MEM), which access the cache memory 20, and that it is necessary to reduce the hit latency of the cache memory 20 in order to improve the throughput of the core 10.

As described above, in order to improve AMAT, global CPU, GPU, and NPU vendors have recently increased the capacity of cache memory 20 to reduce the cache capacity miss rate. However, a continuous increase in the capacity of the cache memory 20 increases the area, which results in an increase in the distance between the core 10 and the cache memory 20 and an increase in the complexity of implementation of the cache memory 20, such as address decoding, data retrieval, and the like. As a result, the hit latency may increase. When access to the instruction/data cache corresponds to the critical path latency of the core 10 due to the increased hit latency, the performance of the core 10 may be degraded.

In an embodiment, in order to solve the above-described problem, the core 10 performs operations under the assumption of a cache hit without tag comparison to hide the cache tag access latency when accessing the instruction/data cache.

That is, when it performs the operation of reading from the instruction/data cache, the core 10 assumes a cache hit and reads in advance a tag and a word corresponding to a block offset in each of valid cache entries in the set from the instruction/data cache into the internal register, without tag comparison.

Then, while the core 10 performs the operation after the cache hit for each word, the tag comparison unit 11 in the core 10 compares the tag of the memory address with each of the tags of the multiple cache entries stored in the internal register.

The tag comparison unit 11 in the core 10 performs tag comparison, and when a cache hit occurs, the core 10 transfers a valid signal only for the operation corresponding to the cache hit.

Conversely, when a cache miss occurs, the core 10 transfers an invalidation signal for all of the operations that assumed a cache hit, and it allocates a cache entry and copies a cache entry from the main memory 30 in the same manner as an operation performed when a cache miss occurs in the conventional method. The core 10 reads the word corresponding to the block offset in the cache entry copied from the main memory 30 as read data.

When it performs the operation of writing to the data cache, the core 10 assumes a cache hit and reads in advance the tags of valid cache entries in a set from the data cache without tag comparison, and write data is stored in the register within the core 10 first. Then, the tag comparison unit 11 in the core 10 compares each of the tags.

The tag comparison unit 11 in the core 10 performs tag comparison, and when a cache hit occurs, the core 10 stores the write data at the word corresponding to the block offset in the cache-hit cache entry.

When a cache miss occurs, the core 10 allocates a cache entry and copies a cache entry from the main memory 30 in the same manner as an operation performed when a cache miss occurs in a conventional method. The core 10 stores the write data at the word corresponding to the block offset in the cache entry copied from the main memory 30.

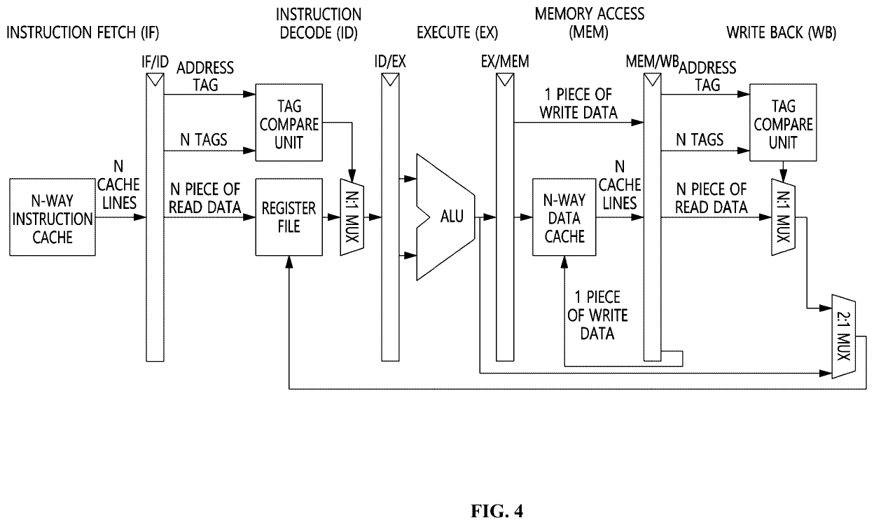

FIG. 4 illustrates the structure of an instruction pipeline of a core according to an embodiment.

Referring to FIG. 4, in the instruction pipeline stages according to an embodiment, the stage of accessing the instruction cache memory 20 is Instruction Fetch (IF), and the stage of accessing the data cache memory 20 is Memory Access (MEM).

In an embodiment, the operation of reading the tags and words of valid cache entries in the cache set, indicated by the cache set index, into the register within the core 10 is performed without tag comparison. Therefore, for the read operation, a number of registers equal to the number of ways, each having a size equal to the sum of tag and word sizes, are required to be added to the core 10.

Also, in an embodiment, the operation of writing to the register within the core 10 is performed without tag comparison. Therefore, for the write operation, a number of registers equal to the number of ways, each having a size equal to a tag size, and a single register having a size equal to a word size to store the write data are required to be added to the core 10.

For the read operation, the core 10 performs the operations after the cache access a number of times equal to the number of ways in the Instruction Decode (ID) and Write Back (WB) stages, which follow Instruction Fetch (IF) and Memory Access (MEM), and the tag comparison unit 11 in the core 10 determines a cache hit/miss by performing tag comparison before the instruction pipeline proceeds to the next stage. When a cache hit occurs, the core 10 transfers a valid signal only for the cache-hit word, whereas when a cache miss occurs, the core 10 transfers an invalidation signal for all of the words and accesses the main memory 30.

For the write operation, the tag comparison unit 11 in the core 10 determines a cache hit/miss by performing tag comparison in the Write Back (WB) stage before the instruction pipeline proceeds to the next stage. When a cache hit occurs, the core 10 transfers the write data stored in the register within the core 10 to the cache-hit word, whereas when a cache miss occurs, the core 10 accesses the main memory 30.

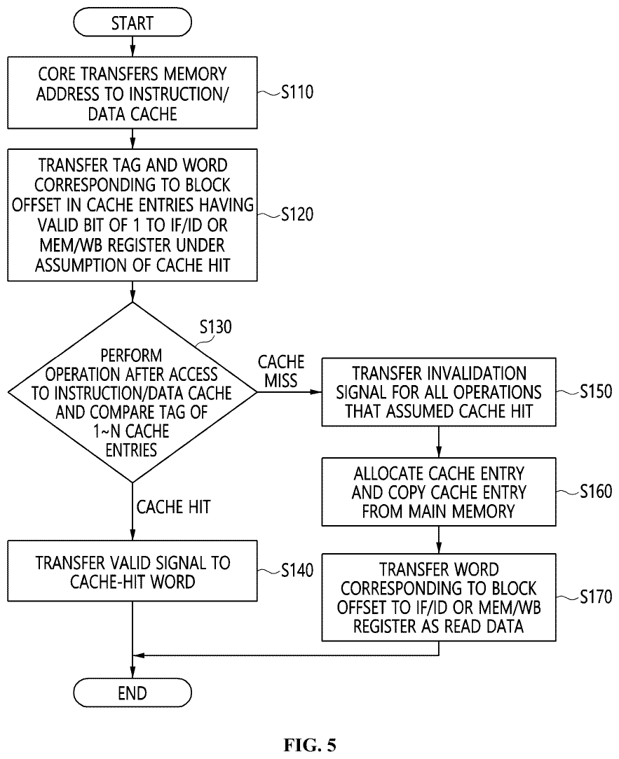

FIG. 5 is a flowchart of the operation of reading from an instruction/data cache in a method for hiding cache tag access latency according to an embodiment.

In the conventional method, when the core 10 performs the operation of reading from the cache memory 20, transferring a memory address to the cache memory 20, comparing tags to check whether a cache entry matching the memory address is present, and reading data are performed.

Here, although transferring the memory address to the cache memory 20 at step S110 is the same in both the conventional method and the present disclosure, the following steps differ, because in the present disclosure, they are performed under the assumption of a cache hit.

That is, in an embodiment, after the data read operation (S120) is performed on the register within the core 10, tag comparison (S130) and the operation after access to the cache memory 20 are performed at the same time.

That is, while the core 10 performs instruction decode or write back, the core 10 executes the tag comparison unit 11 in parallel, whereby the subsequent steps may be performed.

When the tag comparison unit 11 in the core 10 performs tag comparison at step S130, if the result is a cache hit, the core 10 transfers a valid signal only for the operation corresponding to the cache hit at step S140.

Conversely, if the result of performing the tag comparison at step S130 is a cache miss, the core 10 transfers an invalidation signal for all the operations that assumed a cache hit at step S150, and then it allocates a cache entry and copies a cache entry from the main memory 30 at step S160 in the same manner as an operation performed when a cache miss occurs in the conventional method. Subsequently, the core 10 reads the word corresponding to the block offset in the cache entry copied from the main memory 30 as read data at step S170.

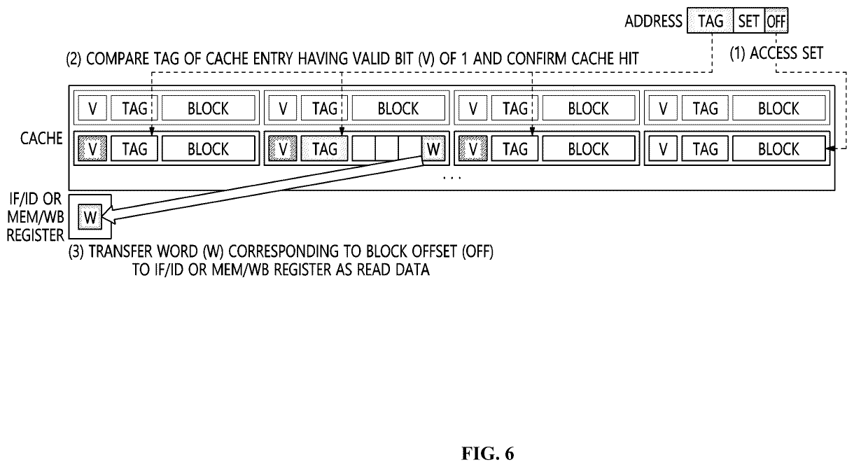

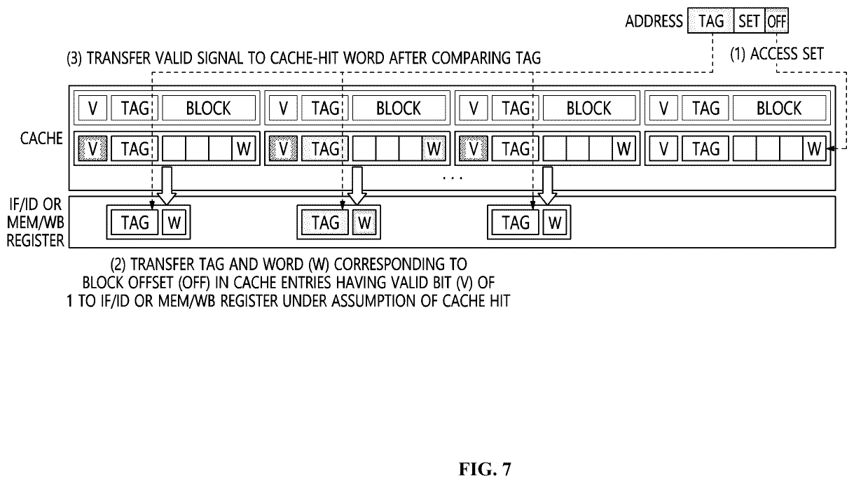

FIG. 6 is an exemplary view for explaining a read operation when an instruction/data cache hit occurs in a conventional method, and FIG. 7 is an exemplary view for explaining a read operation when an instruction/data cache hit occurs according to an embodiment.

Although the process (1) in which the core 10 accesses the cache memory 20 corresponding to the set index of a memory address is the same in both the conventional method and the present disclosure, the following steps differ because, in the present disclosure, they are performed under the assumption of a cache hit.

Referring to FIG. 6, in the conventional method, after accessing the cache set (1), the core 10 searches for a cache entry having a valid bit of 1 and a tag identical to the tag of the memory address in the cache set (2) and loads a word corresponding to the block offset in the cache entry as read data (3).

However, referring to FIG. 7, in an embodiment of the present disclosure, a number of registers equal to the number of ways, each having a size equal to the sum of the tag and word sizes, are added to the core 10, and the core 10 loads the tags and words of the cache entries having a valid bit of 1 in the set (2).

Subsequently, while the core 10 performs instruction decode or write back, the core executes the tag comparison unit 11 in parallel, whereby the subsequent steps may be performed.

At the subsequent step, after the tag comparison unit 11 in the core 10 checks for a cache hit, the core 10 transfers a valid signal only to the cache-hit word (3).

Compared to the conventional method, the present disclosure requires the addition of several registers to the core 10, but it transfers the tags and words of valid cache entries to the registers within the core 10 first without tag comparison and then performs the operation after the cache access, so the operating frequency of the core 10 is increased, which results in performance improvement.

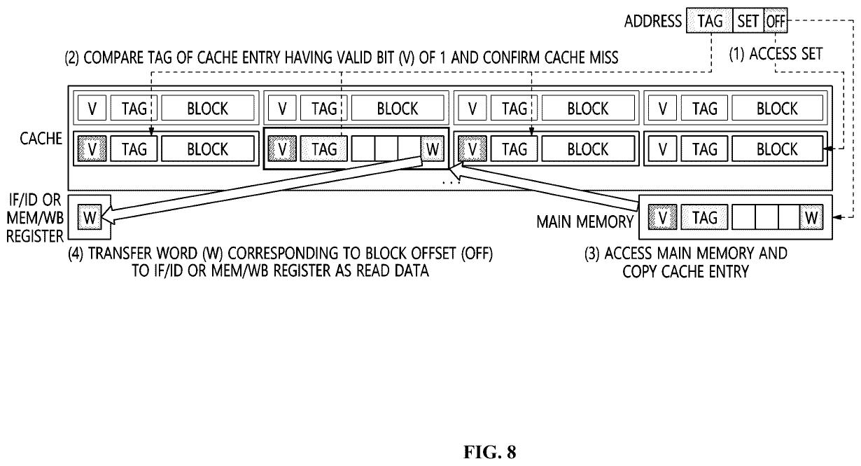

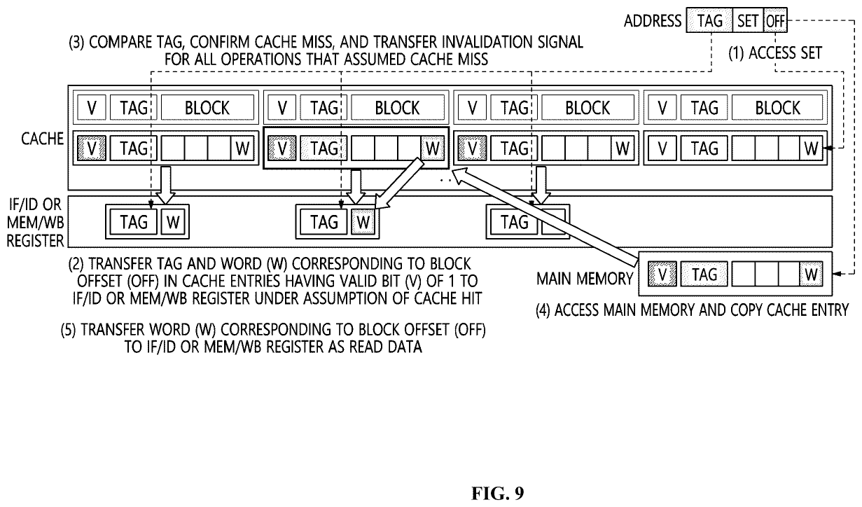

FIG. 8 is an exemplary view for explaining a read operation when an instruction/data cache miss occurs in the conventional method, and FIG. 9 is an exemplary view for explaining a read operation when an instruction/data cache miss occurs according to an embodiment.

Although the process (1) in which the core 10 accesses the cache memory 20 corresponding to the set index of a memory address is the same in both the conventional method and the present disclosure, the following steps differ because, in the present disclosure, they are performed under the assumption of a cache hit.

Referring to FIG. 8, in the conventional method, after accessing the cache set (1), the core 10 fails to find a cache entry having a valid bit of 1 or having a tag identical to the tag of the memory address (2) in the set, so it accesses the main memory 30. The core 10 copies the cache entry from the main memory 30 into the cache memory 20 (3) and loads the word corresponding to the block offset in the cache entry as read data (4).

However, referring to FIG. 9, in an embodiment of the present disclosure, a number of registers equal to the number of ways, each having a size equal to the sum of the tag and word sizes, are added to the core 10, and the core 10 loads the tags and words of the cache entries having a valid bit of 1 in the set (2) first.

Subsequently, while the core 10 performs instruction decode or write back, the core executes the tag comparison unit 11 in parallel, whereby the subsequent steps may be performed.

That is, at the subsequent step, after the tag comparison unit 11 in the core 10 confirms a cache miss, the core 10 transfers an invalidation signal to all blocks (3) and accesses the main memory 30. The core 10 copies the cache entry from the main memory 30 into the cache memory 20 (4) and loads the word corresponding to the block offset in the cache entry as read data (5).

Compared to the conventional method, the present disclosure requires the addition of several registers to the core 10 and requires one cycle for the core 10 to transfer an invalidation signal to all the cache-missed words. However, access to the main memory 30 caused due to the cache miss results in tens of cycles, so the consumption of one cycle for transferring an invalidation signal is only a fraction of the tens of cycles.

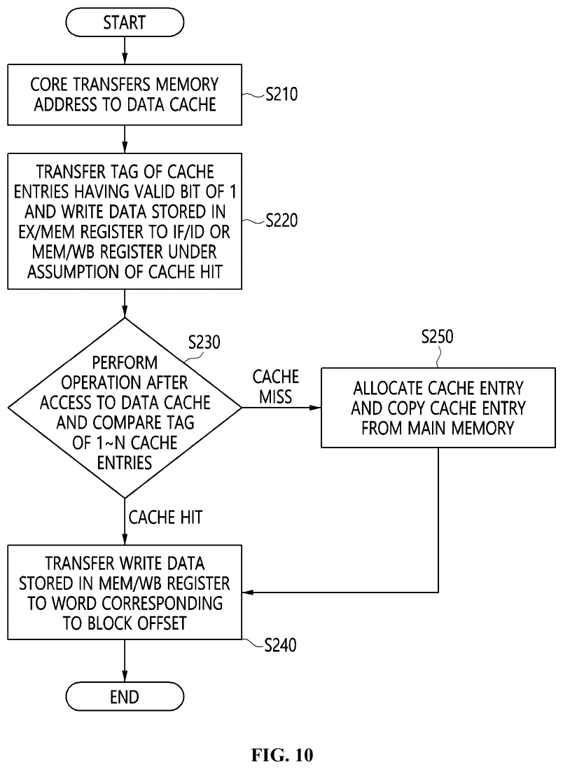

FIG. 10 is a flowchart of the operation of writing to an instruction/data cache in the method for hiding cache tag access latency according to an embodiment.

In the conventional method, when the core 10 performs the operation of writing to the cache memory 20, transferring a memory address to the cache memory 20, comparing tags to check whether a cache entry matching the memory address is present, and writing data are performed.

Although transferring the memory address to the cache memory 20 at step S210 is the same in both the conventional method and the present disclosure, the following steps differ because, in the present disclosure, they are performed under the assumption of a cache hit.

In the present disclosure, the operation of writing data to the register within the core 10 is performed first at step S220, and tag comparison and the operation after access to the cache memory 20 are performed at the same time.

That is, while the core 10 performs instruction decode or write back, the core 10 executes the tag comparison unit 11 in parallel, whereby the subsequent steps may be performed.

When the tag comparison unit 11 in the core 10 performs tag comparison at step S230, if the result is a cache hit, the core 10 stores write data at the word corresponding to the block offset in the cache-hit cache entry at step S240.

Conversely, when the result of performing tag comparison by the tag comparison unit 11 in the core 10 at step S230 is a cache miss, the core 10 allocates a cache entry and copies a cache entry from the main memory 30 at step S250 in the same manner as an operation performed when a cache miss occurs in the conventional method. The core 10 stores the write data at the word corresponding to the block offset in the cache entry copied from the main memory 30.

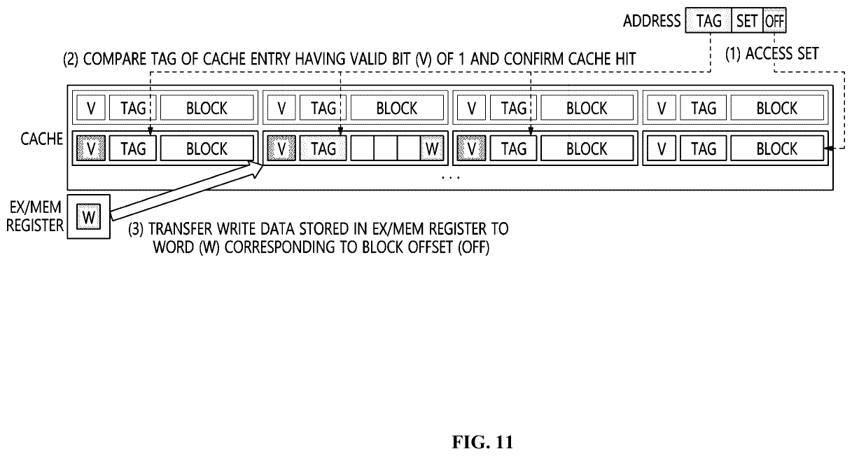

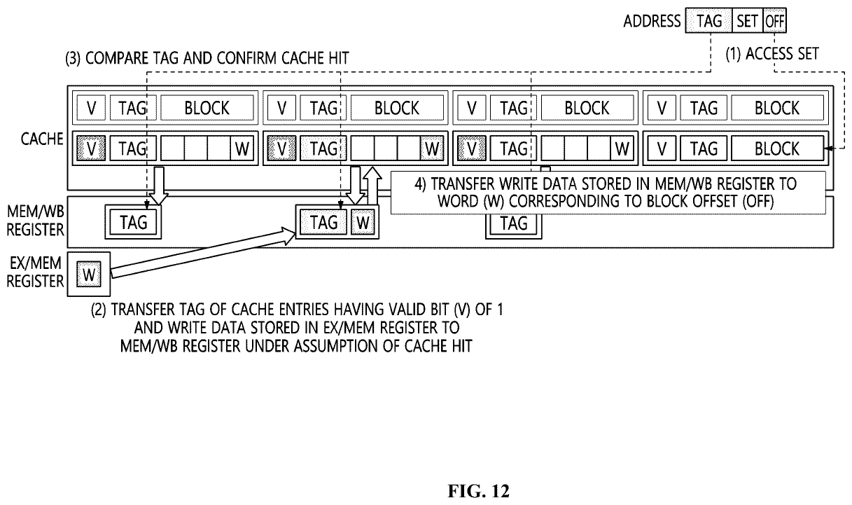

FIG. 11 is an exemplary view for explaining a write operation when an instruction/data cache hit occurs in a conventional method, and FIG. 12 is an exemplary view for explaining a write operation when an instruction/data cache hit occurs according to an embodiment.

Although the process in which the core 10 accesses the cache memory 20 corresponding to the set index of a memory address is the same in both the conventional method and the present disclosure, the following steps differ because, in the present disclosure, they are performed under the assumption of a cache hit.

Referring to FIG. 11, in the conventional method, after accessing the cache set (1), the core 10 searches for a cache entry having a valid bit of 1 and a tag identical to the tag of the memory address in the set (2) and stores the write data at the word corresponding to the block offset in the cache entry (3).

However, referring to FIG. 12, in an embodiment of the present disclosure, a number of registers equal to the number of ways, each having a size equal to the tag size, are added to the core 10 such that the core 10 loads the tags of the cache entries having a valid bit of 1 in the set, and a single register is added to the core 10 such that the core 10 stores the write data in the corresponding register (2).

Subsequently, while the core 10 performs instruction decode or write back, the core 10 executes the tag comparison unit 11 in parallel, whereby the subsequent steps may be performed.

At the subsequent step, after the tag comparison unit 11 in the core 10 checks for a cache hit (3), the core 10 stores the write data in the cache-hit word (4).

Compared to the conventional method, it is necessary to add several registers to the core 10. However, the write data is first transferred to the register added to the core 10 without tag comparison, and then the operation after the cache access is performed, so the operating frequency of the core 10 is increased, which may improve performance.

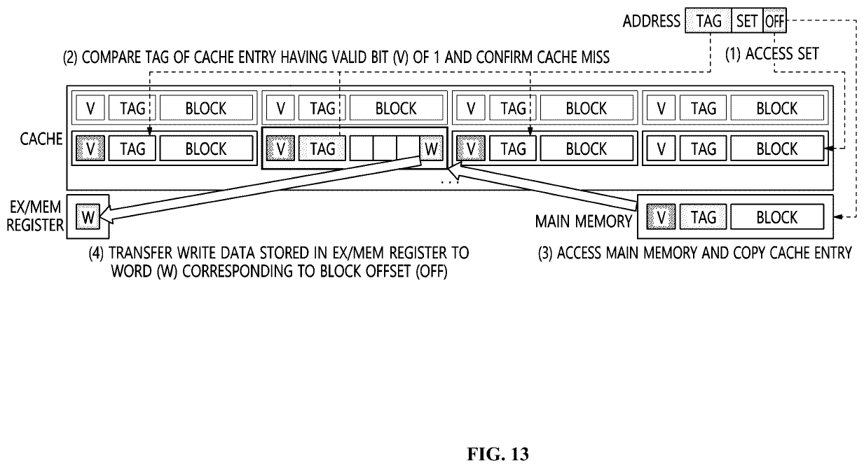

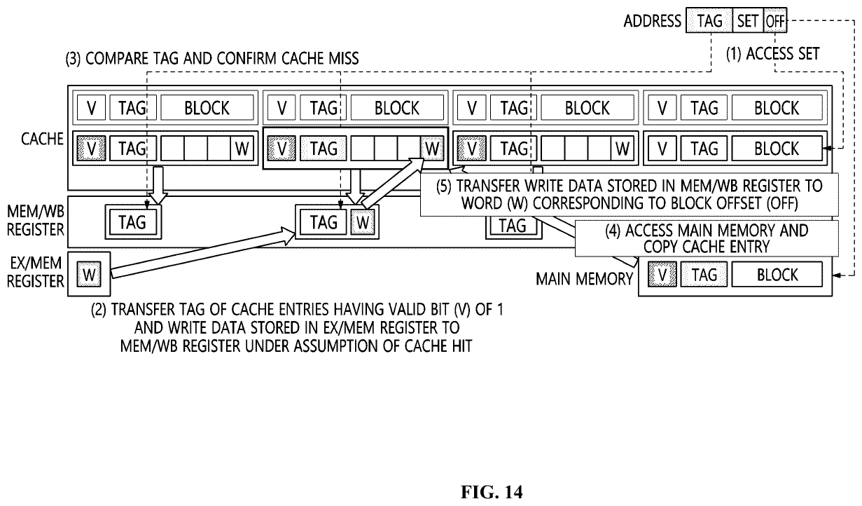

FIG. 13 is an exemplary view for explaining a write operation when an instruction/data cache miss occurs in a conventional method, and FIG. 14 is an exemplary view for explaining a write operation when an instruction/data cache miss occurs according to an embodiment.

Although the process in which the core 10 accesses the cache memory 20 corresponding to the set index of a memory address is the same in both the conventional method and the present disclosure, the following steps differ because, in the present disclosure, they are performed under the assumption of a cache hit.

Referring to FIG. 13, in the conventional method, after accessing the cache set (1), the core 10 fails to find a cache entry having a valid bit of 1 or having a tag identical to the tag of the memory address in the set (2), so it accesses the main memory 30. The core 10 copies the cache entry from the main memory 30 into the cache memory 20 (3) and stores the write data at the word corresponding to the block offset in the cache entry (4).

However, referring to FIG. 14, in an embodiment of the present disclosure, a number of registers equal to the number of ways, each having a size equal to the tag size, are added to the core 10 such that the core 10 loads the tags of cache entries having a valid bit of 1 in the set, and a single register is added to the core 10 such that the core 10 stores the write data in the corresponding register (2).

Subsequently, while the core 10 performs instruction decode or write back, the core 10 executes the tag comparison unit 11 in parallel, whereby the subsequent steps may be performed. At the subsequent step, after the tag comparison unit 11 in the core 10 confirms a cache miss (3), the core 10 accesses the main memory 30 (4). The core 10 copies the cache entry from the main memory into the cache memory 20 and stores the write data at the word corresponding to the block offset in the cache entry (5).

Compared to the conventional method, it is necessary to add several registers to the core 10, and one cycle is required to transfer an invalidation signal to all the cache-missed words. However, memory access caused due to the cache miss results in tens of cycles, so the consumption of one cycle for transferring an invalidation signal is only a fraction of the tens of cycles.

According to the disclosed embodiment, the time taken for a core to access cache memory is reduced, whereby the performance of the core may be improved.

That is, according to the disclosed embodiment, tag comparison during a cache memory access process is performed simultaneously with an operation performed after access to the cache memory by a core, whereby the time taken for the core to access the cache memory may be reduced. In addition, when it is assumed that the critical path latency of the core is the cache memory access time due to the continuous increase in the capacity of the cache memory, the operating frequency of the core may increase by decreasing the cache memory access time according to an embodiment, whereby the performance of the core may be improved.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A method for hiding cache tag access latency, comprising:
transferring, by a core, a memory address to cache memory;
transferring, by the core, data of the cache memory to an internal register of the core;
comparing, by the core, a tag included in the memory address with each of tags of cache entries stored in the internal register; and
performing, by the core, a data read operation corresponding to the memory address based on a result of comparing the tag.

2. The method of claim 1, wherein comparing the tag and performing the data read operation are performed in parallel while the core performs instruction decode or write back.

3. The method of claim 1, wherein transferring the data of the cache memory comprises transferring a tag and a word corresponding to a block offset in each of cache entries having a valid bit of 1 to the internal register under an assumption of a cache hit.

4. The method of claim 1, wherein performing the data read operation comprises transferring a valid signal to a cache-hit word when the result of comparing the tag is a cache hit.

5. The method of claim 1, wherein performing the data read operation comprises when the result of comparing the tag is a cache miss, transferring, by the core, an invalidation signal for all operations that assumed a cache hit;
allocating a cache entry and copying a cache entry from main memory; and
transferring a word corresponding to a block offset in the cache entry copied from the main memory to the internal register as read data.

6. A method for hiding cache tag access latency, comprising:
transferring, by a core, a memory address to cache memory;
transferring, by the core, data of the cache memory to an internal register of the core;
comparing, by the core, a tag included in the memory address with each of tags of cache entries stored in the internal register; and
performing, by the core, a data write operation corresponding to the memory address based on a result of comparing the tag.

7. The method of claim 6, wherein comparing the tag and performing the data write operation are performed in parallel while the core performs instruction decode or write back.

8. The method of claim 6, wherein transferring the data of the cache memory comprises transferring a tag and a word corresponding to a block offset in each of cache entries having a valid bit of 1 to the internal register under an assumption of a cache hit.

9. The method of claim 6, wherein performing the data write operation comprises transferring write data stored in the internal register to a word corresponding to a block offset when the result of comparing the tag is a cache hit.

10. The method of claim 6, wherein performing the data write operation comprises, when the result of comparing the tag is a cache miss, allocating a cache entry and copying a cache entry from main memory.

11. An apparatus for hiding cache tag access latency, comprising:
main memory;
cache memory including multiple cache entries; and
a core for processing instructions,
wherein:
the core includes an internal register for storing data of the multiple cache entries of the cache memory and a tag comparison unit for comparing a tag of a memory address with each of tags of the multiple cache entries stored in the internal register and performs a data read or write operation corresponding to the memory address based on a result of comparing the tag.

12. The apparatus of claim 11, wherein, while the core performs instruction decode or write back, the core executes the tag comparison unit in parallel and performs the data read operation based on the result of comparing the tag.

13. The apparatus of claim 11, wherein the core transfers a tag and a word corresponding to a block offset in each of cache entries having a valid bit of 1 to the internal register under an assumption of a cache hit.

14. The apparatus of claim 11, wherein, when performing the data read operation, the core transfers a valid signal to a cache-hit word if the result of comparing the tag is a cache hit.

15. The apparatus of claim 11, wherein, when performing the data read operation, if the result of comparing the tag is a cache miss, the core transfers an invalidation signal for all operations that assumed a cache hit, allocates a cache entry and copies a cache entry from the main memory, and transfers a word corresponding to a block offset in the cache entry copied from the main memory to the internal register as read data.

16. The apparatus of claim 11, wherein, while the core performs instruction decode or write back, the core executes the tag comparison unit in parallel and performs the data write operation based on the result of comparing the tag.

17. The apparatus of claim 11, wherein, when performing the data write operation, the core transfers write data stored in the internal register to a word corresponding to a block offset if the result of comparing the tag is a cache hit.

18. The apparatus of claim 11, wherein, when performing the data write operation, the core allocates a cache entry and copies a cache entry from the main memory if the result of comparing the tag is a cache miss.
